(19) United States
(12) Patent Application Publication
(10) Pub. No.: US 2024/0334560 A1
(43) Pub. Date: Oct. 3, 2024

(54) COUNTERTOP APPLIANCE WITH INTEGRATED WIRELESS POWER SYSTEM

(71) Applicant: Midea Group Co., Ltd., Shunde (CN)

(72) Inventor: Daniel J. Trice, Louisville, KY (US)

(21) Appl. No.: 18/190,209

(22) Filed: Mar. 27, 2023

(51) Int. Cl. H05B 6/66; H02J 50/10; H02J 50/40; H02J 50/80; H02J 50/90

(52) U.S. Cl. CPC H05B 6/664; H02J 50/10; H02J 50/40; H02J 50/80; H02J 50/90

(57) ABSTRACT

A countertop appliance includes an integrated wireless power system that is capable of supplying wireless power to a wirelessly powered appliance positioned proximate the countertop appliance, but that is also capable of being moved out of the way when not in use, thereby reducing the overall countertop footprint of the countertop appliance, while also reducing clutter and clearing the countertop for other uses. In some instances, the countertop appliance may cool a wireless power transmitter of the integrated wireless power system, and in some instances, the countertop appliance may be capable of controlling a wirelessly powered appliance while the wirelessly powered appliance is powered by the integrated wireless power system.

### BACKGROUND

A wide variety of kitchen appliances are commonly used in single-family and multi-family residential applications. Many of these appliances, e.g., dishwashers, wine coolers, refrigerators, laundry washing machines, ovens, ranges, cooktops, etc., are installed in a “built-in” fashion such as under a countertop, within a cut-out formed in the countertop, or in a designated opening in the arrangement of kitchen cabinets. Built-In appliances are often hard-wired into a household electrical circuit or are plugged in to a dedicated electrical outlet that is generally hidden from view when the appliance is in its installed location.

Many consumers, however, also rely on various smaller kitchen appliances to perform more specific tasks, including, for example, microwave ovens, rice cookers, blenders, mixers, food processors, toasters, air fryers, pressure cookers, coffee makers, espresso machines, etc. While sometimes these appliances are stored on the countertop when not in use, in other instances these appliances may be stored in the cabinets or elsewhere and brought out when needed. To power such devices, many kitchens include electrical outlets on the wall between the upper cabinets and the countertop, which is often referred to as a backsplash, so that such appliances may be plugged in when needed. The power cords used by such appliances, however, can be cumbersome and unsightly, both during use and in storage.

More recently, it has been proposed to use wireless power for smaller kitchen appliances, e.g., based upon the Ki Kitchen Cordless Standard developed by the Wireless Power Consortium. Rather than relying on a power cord plugged into an electrical outlet, a wirelessly-powered appliance includes a wireless power receiver that is oriented on the bottom of the appliance to receive power wirelessly from a wireless power transmitter that is embedded in a cooktop, a countertop or table when the appliance is positioned directly over the wireless power transmitter.

Integrating a wireless power transmitter into a countertop or table in an existing kitchen, however, can be problematic and expensive. Many wireless power transmitters, for example, are intended to be installed underneath or within a countertop and are hard-wired into a household electrical circuit, so existing countertops may need to be removed, and new wiring run, in order to retrofit a kitchen for wireless power. Therefore, a substantial need exists in the art for a more cost effective and convenient manner of supplying power to a wirelessly powered appliance, particularly in an existing kitchen.

### SUMMARY

The herein-described embodiments address these and other problems associated with the art by providing a countertop appliance with an integrated wireless power system that is capable of supplying wireless power to a wirelessly powered appliance positioned proximate the countertop appliance, but that is also capable of being moved out of the way when not in use, thereby reducing the overall countertop footprint of the countertop appliance, while also reducing clutter and clearing the countertop for other uses. In some instances, the countertop appliance may cool a wireless power transmitter of the integrated wireless power system, and in some instances, the countertop appliance may be capable of controlling a wirelessly powered appliance while the wirelessly powered appliance is powered by the integrated wireless power system.

Therefore, consistent with one aspect of the invention, a countertop appliance may include a housing configured to support the countertop appliance on a countertop, one or more electrical loads coupled to the housing and configured to perform one or more primary appliance functions for the countertop appliance, a movable platform, and a wireless power transmitter supported by the movable platform and configured to generate a wireless power signal. The movable platform may be movable between a use position and a storage position, such that when in the use position, the movable platform positions the wireless power transmitter proximate to the countertop to power a wirelessly powered appliance positioned proximate thereto with the wireless power signal, and when in the storage position, the movable platform repositions the wireless power transmitter to reduce an overall countertop footprint of the countertop appliance.

In some embodiments, the countertop appliance is a countertop microwave cooking appliance and the one or more electrical loads includes a microwave power generator. Also, in some embodiments, the movable platform is configured to position the wireless power transmitter under the housing when in the storage position. Further, in some embodiments, the movable platform is movable linearly between the use and storage positions. In some embodiments, the movable platform is supported under the housing by a pair of opposing slides.

In addition, in some embodiments, the movable platform is movable in a direction between a front and a back of the housing, and when in the use position the wireless power transmitter is positioned in front of the housing on the countertop. In some embodiments, the movable platform is movable in a direction between left and right sides of the housing, and when in the use position the wireless power transmitter is positioned to a left or right of the housing on the countertop. In addition, in some embodiments, the movable platform is rotatable between the use and storage positions.

Moreover, in some embodiments, the movable platform is configured to position the wireless power transmitter against a side of the housing when in the storage position, and the movable platform is rotatably coupled to the housing to flip down into the use position. Some embodiments may also include an automated retraction/extension mechanism coupling the movable platform to the housing and configured to move the movable platform between the storage and use positions. In some embodiments, when in the use position, the movable platform is supported by the countertop.

Some embodiments may further include a cooling fan positioned to cool at least one of the one or more electrical loads coupled to the housing, and a ducting arrangement configured to receive airflow generated by the cooling fan and route the airflow to the movable platform when in the use position to cool the wireless power transmitter during use. In some embodiments, the ducting arrangement includes an outlet port coupled to the housing and an inlet port coupled to the movable platform, and the outlet port is aligned with the inlet port when the movable platform is in the use position. In addition, in some embodiments, movement of the movable platform away from the use position separates the inlet port from the outlet port. In some embodiments, the movable platform blocks the outlet port when in the storage position. Moreover, in some embodiments, the movable platform is movable linearly between the use and storage positions and includes a side surface, the inlet port is disposed on the side surface, and the side surface opposes the outlet port when the movable platform is in the storage position.

Also, in some embodiments, the wirelessly powered appliance is a first wirelessly powered appliance, and the wireless power transmitter is configured to supply power to a second wirelessly powered appliance including one or more electric loads and lacking a power storage element sufficient to otherwise power the second wirelessly powered appliance. In some embodiments, the wireless power transmitter is further configured to inductively heat a utensil placed in proximity to the wireless power transmitter.

In addition, some embodiments may also include a user interface, and a controller coupled to the user interface and the one or more electrical loads to operate the one or more electrical loads in response to user input directed to the user interface. The controller may be further configured to communicate with the wirelessly powered appliance when the wirelessly powered appliance is being powered by the wireless power transmitter and to communicate a command to operate the wirelessly powered appliance in response to user input directed to the user interface. Also, in some embodiments, the controller may be further configured to receive identifying data from the wirelessly powered appliance when the wirelessly powered appliance is being powered by the wireless power transmitter and to configure the user interface to operate the wirelessly powered appliance using the identifying data.

Other embodiments may include various methods for making and/or using any of the aforementioned constructions.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a room incorporating a countertop appliance with integrated wireless power system consistent with some embodiments of the invention.

FIG. 2 is a perspective view of the countertop appliance with integrated wireless power system of FIG. 1.

FIG. 3 is a block diagram of an example control system for the countertop appliance with integrated wireless power system of FIG. 1.

FIG. 4 is a bottom plan view of another example countertop appliance with integrated wireless power system consistent with some embodiments of the invention, and including a front-extending sliding platform.

FIG. 5 is a bottom plan view of another example countertop appliance with integrated wireless power system consistent with some embodiments of the invention, and including a front-extending pivoting platform.

FIG. 6 is a bottom plan view of another example countertop appliance with integrated wireless power system consistent with some embodiments of the invention, and including a side-extending sliding platform.

FIG. 7 is a perspective view of another example countertop appliance with integrated wireless power system consistent with some embodiments of the invention, and including a side-extending flip-down platform.

FIG. 8 is a bottom plan view of another example countertop appliance with integrated wireless power system consistent with some embodiments of the invention, and including a cooling system for the wireless power transmitter thereof.

FIG. 9 is a functional cross-sectional view of the countertop appliance with integrated wireless power system of FIG. 8, taken along lines 9-9 thereof.

FIG. 10 is a functional cross-sectional view of the countertop appliance with integrated wireless power system of FIG. 8, with the platform thereof partially retracted.

FIG. 11 is a flowchart illustrating an operational sequence for controlling a wirelessly powered appliance using a countertop appliance with integrated wireless power system consistent with some embodiments of the invention.

### DETAILED DESCRIPTION

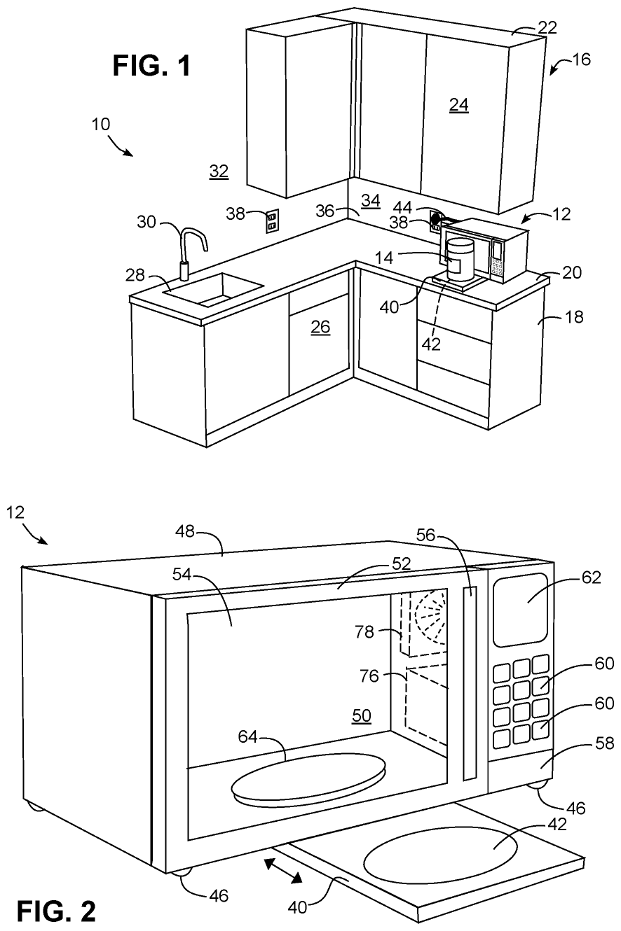

Turning now to the drawings, wherein like numbers denote like parts throughout the several views, FIG. 1 illustrates an example room (e.g., a kitchen) 10 within which is installed a countertop appliance 12 including an integrated wireless power system suitable for powering one or more wirelessly powered appliances, e.g., a wirelessly powered appliance 14 implemented as a pressure cooker in FIG. 1. Room 10 includes a built-in cabinet system 16, which includes one or more base cabinets 18 that support a countertop 20 and one or more upper or wall cabinets 22 that are positioned over countertop 20. Cabinets 18, 22 may include doors, e.g., door 24, in some instances, or may include drawers or open shelves, and it will be appreciated that in some instances, various built-in appliances (e.g., dishwasher 26) may also be mounted or positioned within built-in cabinet system 16 (other appliances include, but are not limited to, refrigerators, ovens, ranges, cooktops, laundry washing machines, dryers, etc.) One or more sinks 28 may also be disposed on countertop 20 and may be supplied with water by a faucet 30.

Cabinets 18, 22 are generally secured along one or more walls 32, 34 in room 10, with wall cabinets 22 generally mounted to walls 32, 34 and positioned above counter height, e.g., above countertop 20, which is supported by base cabinets 18. In the United States, for example, the countertop may be at a height (from the floor) of approximately 36 inches with the wall cabinets at a height (from the floor) of approximately 54 inches, such that the wall area between the countertop and the bottom of the wall cabinets, referred to herein as a backsplash 36, has a height (from the countertop to the bottom of the wall cabinets) of approximately 18 inches. Base cabinets 18 may or may not be secured to walls 32, 34, but are otherwise generally floor standing such that their load is predominantly borne by the floor rather than a wall, which is generally the case for wall cabinets 22.

It will be appreciated that other countertop, wall cabinet, and backsplash heights may be used in other embodiments. It will also be appreciated that room 10 may be any suitable indoor or outdoor living or working space within which it may be desirable to use a wirelessly powered appliance, including rooms lacking any built-in cabinets or countertops. Example types of suitable rooms include a kitchen, bar, entertainment area, bedroom, office area, retail establishment, etc. In some embodiments, room 10 may even be disposed within a boat or recreational vehicle.

Room 10 may also include one or more electrical outlets 38, e.g., disposed on walls 32, 34. In many kitchens, for example, electrical outlets are positioned at various points along backsplash 36 to provide users with multiple locations within which to plug in various small, portable and/or countertop appliances.

With additional reference to FIG. 2, countertop appliance 12 in the illustrated embodiments is implemented as a countertop microwave cooking appliance, and includes a movable platform 40 that includes a wireless power transmitter 42 (occluded by wirelessly powered appliance 14 in FIG. 1). A power cord 44, plugged into an electrical outlet 38, supplies power to countertop appliance 12, although in other embodiments the appliance may be hard-wired.

When not in use, movable platform 40 may be slid rearwardly and be positioned under countertop appliance 12, e.g., in a space defined by feet 46. Then, when it is desirable to use a wirelessly powered appliance, movable platform 40 may be pulled out from under countertop appliance 12, and exposing wireless power transmitter 42. Wirelessly powered appliance 14 may then be placed on movable platform 40 in alignment with wireless power transmitter pad 42 (as illustrated in FIG. 1), and power may be supplied to the wirelessly powered appliance. Then, once use of the wirelessly powered appliance is complete, movable platform 40 may pushed back under countertop appliance 12 and moved out of the way, thereby reducing the overall countertop footprint of the countertop appliance, while also reducing clutter and clearing the countertop for other uses.

As illustrated in FIG. 2, countertop appliance 12 in some embodiments may be a residential-type countertop microwave cooking appliance, and as such includes a housing or enclosure 48, which further includes a cooking cavity 50, as well as a door 52 disposed adjacent the respective opening of the cooking cavity 50. In some embodiments, the door 52 may further include a window 54 that allows a user to view the items inside the cooking cavity 50 and a handle 56. In other embodiments, in place of, or in addition, to the handle 56, countertop appliance 12 may include a button 58 that a user may press to trigger the opening of the door 52.

Countertop appliance 12 may also include one or more user activated controls 60, which may be in the form of buttons, knobs, a touchscreen, or the like. In some embodiments, these user activated controls 60 may be used to program a cooking time and/or a cooking power level. In addition, in some embodiments, these user activated controls 60 may be used to selected one or more preset conditions for a particular food item to be cooked or a particular desired action (e.g. “popcorn”, “defrost”, “frozen pizza”, etc.). Countertop appliance 12 may also include a display 62, which may be used to convey a variety of information to a user. For example, in some embodiments, the display 62 may be used to display the time when countertop appliance 12 is not in use. In other embodiments, the display 62 may be used to display cooking times, power levels and/or temperatures. In addition, as will become more apparent below, user activated controls 60 and/or display 62 may also be configured to control the operation of wireless transmitter 42, and in some embodiments, may also be capable of controlling a wirelessly powered appliance, e.g., wirelessly powered appliance 14.

Countertop appliance 12 may also include a rotatable turntable 64 that is configured to support food to be cooked, e.g., disposed in a container or on a plate. In some embodiments, the turntable 64 may be positioned centrally in the cooking cavity 50, although this is not intended to be limiting. One or more food items may be placed on turntable 64, so that as the turntable rotates so do the one or more food items contained thereon. This rotation may facilitate more even heating (or cooking) of the food item(s). In some instances, such a turntable may be configured to be turned on, off, or otherwise controlled (e.g. rotational speed) in response to various user inputs.

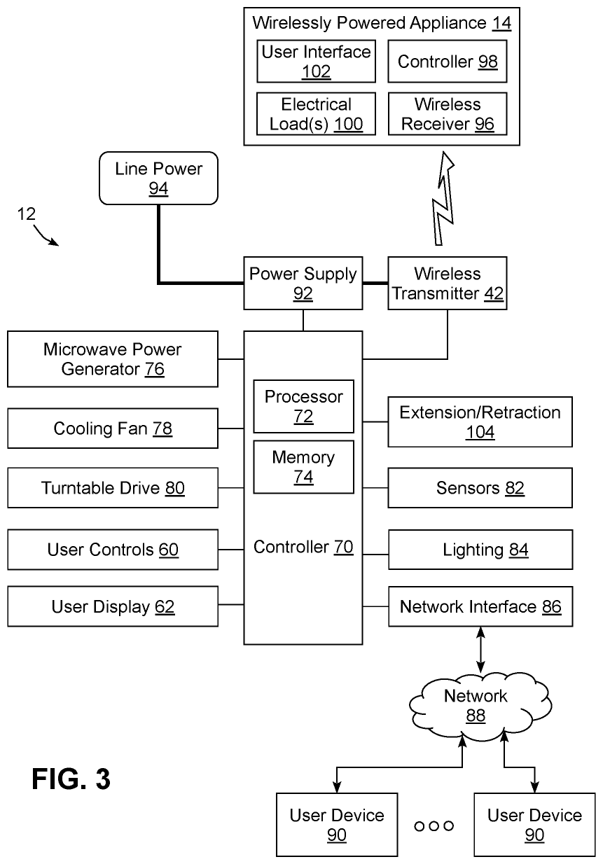

Countertop appliance 12 also generally includes one or more controllers configured to control the application of cooking energy to food disposed in the appliance, and otherwise perform various cooking or heating cycles at the direction of a user. In addition, as noted above, countertop appliance 12 also includes an integrated wireless power system, which may also be controlled by the one or more controllers of the appliance. FIG. 3, for example, illustrates an example embodiment of a controller 70 for countertop appliance 12 that receives inputs from a number of components and drives a number of components in response thereto. Controller 70 may, for example, include one or more processors 72 and a memory 74 within which may be stored program code for execution by the one or more processors. The memory may be embedded in controller 70, but may also be considered to include volatile and/or non-volatile memories, cache memories, flash memories, programmable read-only memories, read-only memories, etc., as well as memory storage physically located elsewhere from controller 70, e.g., in a mass storage device or on a remote computer interfaced with controller 70. Controller 70 may also be implemented at least in part using discrete circuit logic, as will be appreciated by those of ordinary skill having the benefit of the instant disclosure.

As shown in FIG. 3, controller 70 may be interfaced with various components, including the aforementioned user controls 60 for receiving user input (which may be implemented in various embodiments using various combinations of switches, knobs, buttons, sliders, touchscreens or touch-sensitive displays, microphones or audio input devices, image capture devices, etc.), and user display 62 (which may be implemented in various embodiments using various indicators, graphical displays, textual displays, speakers, etc.), which collectively provide a user interface for the countertop appliance.

Further, as illustrated in FIG. 3, controller 70 may be interfaced with a microwave power generator 76, which may include a magnetron, and which in some embodiments may be implemented as a fixed power microwave power generator that is cycled in order to provide different output levels, and in other embodiments may be implemented as a variable power microwave power generator that utilizes an inverter power supply that varies an output power of the microwave power generator in order to provide different output levels. Microwave power generator 76, for the purposes of this disclosure, may be considered to be an electrical load associated with a primary appliance function of the countertop appliance, but it will be appreciated that a countertop appliance in other embodiments may include a wide variety of other types of electrical loads, including various motors, heating elements, solenoids, relays, and various electromechanically-controlled or electronically-controlled components, that are specific to the particular application of the countertop appliance. Thus, it will be appreciated that countertop appliance 12 includes, in addition to an integrated wireless power system, one or more primary appliance functions implemented by one or more electrical loads that are separate from the electrical load represented by the integrated wireless power system (including any electrical load that is used both for wireless power transmission and inductive cooking), such that countertop appliance is not merely an appliance dedicated solely to supplying wireless power to a different wirelessly powered appliance.

In addition, in some embodiments controller 70 may be interfaced with a cooling fan 78 that circulates air within housing 48 to cool microwave power generator 76, as well as other components, and a turntable drive 80 that is used to rotate the turntable. Controller 70 may also be interfaced with various additional components, e.g., various sensors 82 suitable for use in a microwave cooking appliance, e.g., temperature sensors, door switches, etc., as well as a lighting system 84. In addition, in some embodiments, countertop appliance 12 may be a “smart” appliance with network connectivity, and controller 70 may be coupled to one or more network interfaces 86, e.g., for interfacing with external devices via wired and/or wireless networks such as Ethernet, Wi-Fi, Bluetooth, NFC, optical, cellular and other suitable networks, collectively represented in FIG. 2 at 88. Network 88 may incorporate in some embodiments a home automation network, and various communication protocols may be supported, including various types of home automation communication protocols. In some embodiments, countertop appliance 12 may also be interfaced with one or more user devices 90 over network 88, e.g., computers, laptops, tablets, smart phones, wearable devices, personal digital assistants, automated assistants, etc., and through which countertop appliance 12 may be controlled and/or countertop appliance 12 may provide user feedback. Connectivity to various remote services may also be supported through network 88.

Controller 70 may be powered by a power supply 92, e.g., an AC-DC power supply that is coupled to line power 94 (e.g., 120-240 VAC, as may be provided by a residential electrical circuit), via an electrical outlet and plug, or alternatively, a hard-wired connection. Line power 94 also supplies wireless power transmitter 42 with power. Controller 70 may control wireless power transmitter 42 to selectively activate/deactivate the wireless power transmitter, to regulate the power output of the wireless power transmitter, to communicate data to and/or receive data from wirelessly powered appliance 14, etc. In the illustrated embodiment, wireless power transmitter 42 is compatible with the Ki Kitchen Cordless Standard developed by the Wireless Power Consortium, although other wireless power or charging standards may be used in other embodiments, including, for example, the Qi Wireless Charging Standard also developed by the Wireless Power Consortium. It will be appreciated that the control over wireless power transmitter 42 by controller 70 to emit a wireless power signal would be well within the abilities of those of ordinary skill having the benefit of the instant disclosure.

Wirelessly powered appliance 14 may include a wireless power receiver 96 that, when positioned proximate wireless power transmitter 44, receives a wireless power signal to supply power to the wirelessly powered appliance. Wirelessly powered appliance 60 may also include a controller 98 to operate wireless power receiver 96, as well as to perform other appliance-related functions. Power received by wireless power receiver 96 may be used to also power one or more electrical loads 100, e.g., motors, heating elements, displays, etc., as well as controller 98 itself.

In some embodiments, wirelessly powered appliance 14 may include a user interface 102 to operate the appliance, and, beyond the supply of wireless power, may operate completely independently from countertop appliance 12. In other embodiments, however, countertop appliance 12 may be functionally integrated with wirelessly powered appliance 14, e.g., such that user controls 60 and/or user display 62 of countertop appliance 12 may be used to display information received from wirelessly powered appliance 14 and/or control one or more functional operations of wirelessly powered appliance 14 beyond simply controlling the supply of power to the wirelessly powered appliance. In some embodiments, for example, wirelessly powered appliance 14 may omit any separate user interface, and may be operated through the user interface defined by user controls 60 and/or user display 62 of countertop appliance 12. Communication between countertop appliance 12 and wirelessly powered appliance 14 may be over a Near Field Communication (NFC) wireless link as supported by the Ki standard, or via a separate wired or wireless network.

It may also be desirable to provide within sensors 82 one or more sensors for sensing various states associated with the integrated wireless power system of countertop appliance 12. For example, a position sensor may be used in some embodiments to detect the position of movable platform 40, e.g., when the integrated wireless power system is in a storage and/or use configuration, and may be used, for example, to automatically turn the integrated wireless power system on or off when it is transitioned between the storage and use configurations. In addition, a temperature sensor and/or current sensor may be used in some embodiments to monitor wireless power transfer and prevent overheating. Other suitable sensors will be appreciated by those of ordinary skill having the benefit of the instant disclosure.

Furthermore, countertop appliance 12 may also include an automated extension/retraction mechanism 104 capable of transitioning platform 42 between the storage and use configurations. In addition, in some embodiments, wireless power transmitter 42 may also be capable of serving as an inductive power source for cooking, such that, for example, if a suitable pot or pan is placed on the wireless power transmitter, the wireless power transmitter operates as an induction cooktop to generate heat for cooking food. As such, induction cooktop controls and/or displays may also be provided in countertop appliance 12 in some embodiments, which may be separate from or integrated with the user interfaced used to control the countertop appliance itself.

It should be appreciated that wireless power is distinguished from wireless charging in the context of the present disclosure, as while an integrated wireless power system may in some instances provide power to charge a battery of an appliance or other electronic device wirelessly coupled to the wireless power system, such a use is secondary to providing wireless power to operate the appliance, i.e., to provide the primary power supply to the appliance during its active use. As such, a wirelessly powered appliance in many instances may not include any battery or other power storage element capable of independently providing sufficient power to operate the wirelessly powered appliance, such that the wirelessly powered appliance is effectively inoperable unless coupled to a wireless or wired power source (since some wirelessly powered appliances may also be capable of being plugged in). For many wirelessly powered appliances used for cooking for example, high power draw electrical loads such as electric motors and/or heating elements may be used, and to the extent any power storage element is present on such a wirelessly powered appliance, it is incapable of sufficiently powering such high power draw electrical loads, such that the wirelessly powered appliance is principally powered through an integrated wireless power system as described herein.

In some embodiments, controller 70 may operate under the control of an operating system and may execute or otherwise rely upon various computer software applications, components, programs, objects, modules, data structures, etc. In addition, controller 70 may also incorporate hardware logic to implement some or all of the functionality disclosed herein. Further, in some embodiments, the sequences of operations performed by controller 70 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

In addition, while countertop appliance 12 is implemented as a microwave cooking appliance in the illustrated embodiment, it will be appreciated that a wireless power system may be integrated with a wide variety of other portable and/or countertop appliances in other embodiments, particularly in applications where there is a possibility of the appliance being used in applications where there is limited counterspace, and generally (though not necessarily) where the countertop appliance is typically kept at all times on the countertop rather than being stored and brought out only when it is used. A non-exclusive list of other types of countertop appliances that may incorporate an integrated wireless power system include, for example, other types of ovens or cooking appliances, e.g., countertop ovens, toasters, air fryers, pressure cookers, slow cookers, etc.; coffee machines such as drip coffee makers, espresso machines, etc.; and others that will be apparent to those of ordinary skill having the benefit of the instant disclosure. In addition, the primary appliance functions and electrical loads that a countertop appliance may implement in various embodiments include, for example, cooking or heating food with resistive heating elements, infrared or light emitting heating elements, microwave heating elements, etc., cooling or freezing food with cooling circuits, driving a fan, stirrer, blade, etc. with an electric motor, heating water with a heating element, pumping fluids with a pump, or practically any other suitable function capable of being performed by a countertop appliance.

Numerous variations and modifications to the countertop appliance illustrated in FIGS. 1-3 will be apparent to one of ordinary skill in the art, as will become apparent from the description below. Therefore, the invention is not limited to the specific implementations discussed herein.

Countertop Appliance with Integrated Wireless Power System

As noted above, in the herein-described embodiments, a countertop appliance incorporates an integrated wireless power system that is capable of supplying wireless power to a wirelessly powered appliance positioned proximate the countertop appliance, but that is also capable of being moved out of the way when not in use, thereby reducing the overall countertop footprint of the countertop appliance, while also reducing clutter and clearing the countertop for other uses.

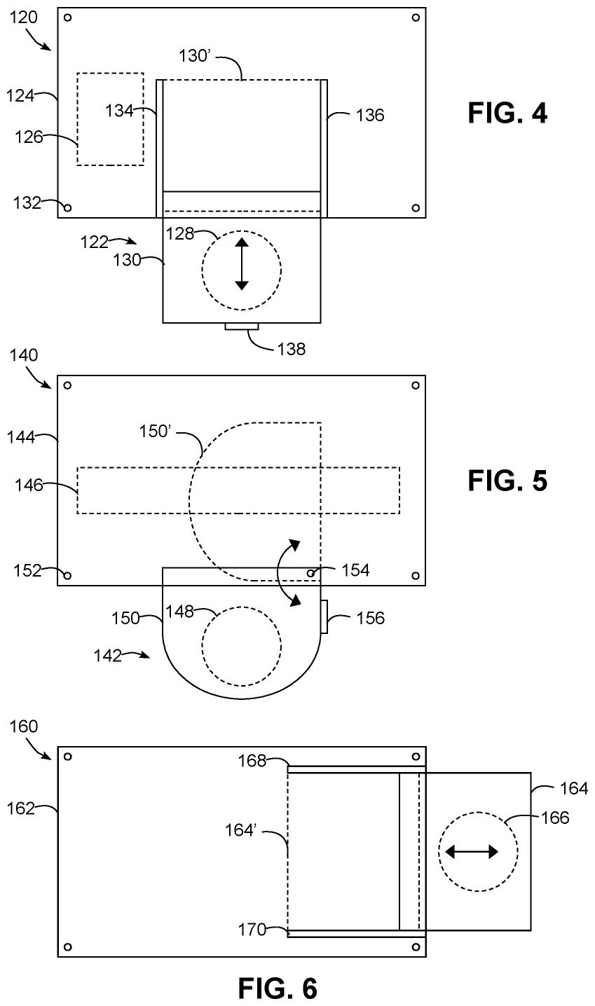

In some embodiments, for example, a countertop appliance may include a housing configured to support the countertop appliance on a countertop, one or more electrical loads coupled to the housing and configured to perform one or more primary appliance functions for the countertop appliance, a movable platform, and a wireless power transmitter supported by the movable platform and configured to generate a wireless power signal. FIG. 4, for example, illustrates a bottom plan view of a countertop appliance 120 similar to countertop appliance 12 of FIGS. 1-3, and including an integrated wireless power system 122. Countertop appliance 120 as illustrated herein is a countertop microwave, and includes a housing 124 and one or more electrical loads, e.g., a microwave power generator 126. Wireless power system 122 includes a wireless power transmitter 128 disposed on a movable platform 130 that is movable between a use position (illustrated in FIG. 4) and a storage position illustrated at 130′. When in the use position, movable platform 130 positions wireless power transmitter 128 proximate to a countertop to power a wirelessly powered appliance positioned proximate thereto with a wireless power signal generated by the wireless power transmitter 128. In addition, movable platform 130 is movable linearly to reposition the wireless power transmitter to reduce an overall countertop footprint of the countertop appliance, e.g., by repositioning the movable platform and wireless power transmitter under the housing. For example, sufficient space may be provided under housing 124, e.g., by feet 132, such that movable platform 130 may be slidable between the front and back of the housing along slides or rails 134, 136. In addition, it may be desirable to include a handle 138 on movable platform 130 to facilitate pulling the movable platform out from under the housing when in the storage position.

It should be noted that, when in the use position, the countertop footprint of countertop appliance 120 includes the footprint of housing 124 and the footprint of movable platform 130. However, when movable platform 130 is pushed under housing 124 to the storage position, the overall countertop footprint of the countertop appliance is reduced to only includes the footprint of housing 124, thereby freeing up the space on the countertop previously covered by movable platform 130 for other uses. In addition, in some embodiments it may be desirable (though it is not required) for movable platform 130 to be supported on the countertop, at least when in the use position, such that the weight of the wirelessly powered appliance is directly supported by the countertop.

Electrical wires, cables or other forms of conductors (not shown in FIG. 4) may be routed between housing 124 and movable platform 130 to supply power to wireless power transmitter 128. In addition, in some embodiments, a release mechanism may be provided to lock movable platform in a use and/or storage position, and in some embodiments, an automated extension/retraction mechanism, e.g., including a linear or rotary drive, may be used to automatically move movable platform 130 between the use and storage positions.

It will also be appreciated that a wireless power transmitter may be positioned on other locations of a countertop appliance, and may be supported on a movable platform that moves in other manners. FIG. 5, for example, illustrates a bottom plan view of a countertop appliance 140 similar to countertop appliance 120 of FIG. 4, and including an integrated wireless power system 142. Countertop appliance 140 as illustrated herein is a countertop air frying oven, and includes a housing 144 and one or more electrical loads, e.g., a resistive heating element 146. Wireless power system 142 includes a wireless power transmitter 148 disposed on a movable platform 150 that is movable between a use position (illustrated in FIG. 5) and a storage position illustrated at 150′. When in the use position, movable platform 150 positions wireless power transmitter 148 proximate to a countertop to power a wirelessly powered appliance positioned proximate thereto with a wireless power signal generated by the wireless power transmitter 148. In addition, movable platform 150 is rotatable to reposition the wireless power transmitter to reduce an overall countertop footprint of the countertop appliance, e.g., by repositioning the movable platform and wireless power transmitter under the housing. For example, sufficient space may be provided under housing 144, e.g., by feet 152, such that movable platform 150 may be rotatable about an axis 154. In addition, it may be desirable to include a handle 156 on movable platform 150 to facilitate pulling the movable platform out from under the housing when in the storage position. In some embodiments, a combination of linear and rotatable movement may also be supported.

In addition, as illustrated in FIG. 6, rather than having a movable platform that is movable in a direction between a front and a back of a housing to position a wireless power transmitter in front of the housing on the countertop when in the use position, a countertop appliance may include a movable platform that is movable in a direction between left and right sides of the housing, such that when in the use position the wireless power transmitter will be positioned to a left or right of the housing on the countertop. FIG. 6, for example, illustrates a countertop appliance 160 including a housing 162 and a movable platform 164 that supports a wireless power transmitter 166 and moves between a use position illustrated in FIG. 6 to a storage position as illustrated at 164′, e.g., by sliding from side to side on a pair of slides or rails 168, 170.

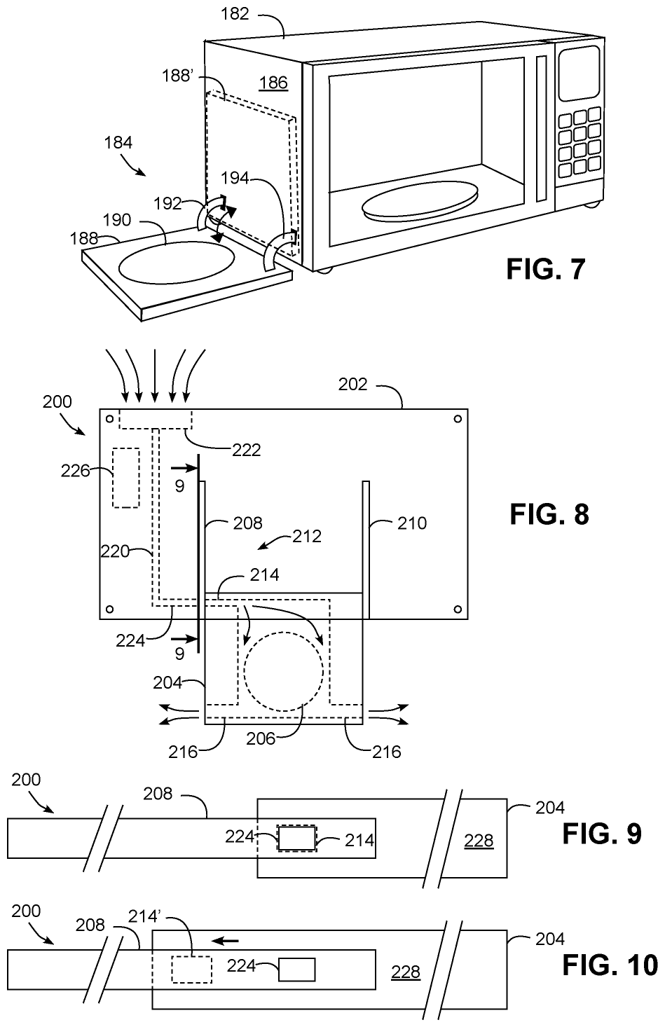

FIG. 7 next illustrates another variation, where a countertop microwave cooking appliance 180 having a housing 182 includes a wireless power system 184 supported on a side 186 of housing 182 and including a movable platform 188 supporting a wireless power transmitter 190. Movable platform 188 is configured to position wireless power transmitter 190 against side 186 of housing 182 (e.g., with the wireless power transmitter facing the side of the housing) when in the storage position represented at 188′, side of the housing when in the storage position. In addition, movable platform 188 is rotatably coupled to housing 182, e.g., by a pair of hinges 192, 194 positioned proximate a bottom of the housing to enable the movable platform to flip down into the use position illustrated in FIG. 7.

It will be appreciated that a flip-down movable platform in other embodiments may flip down from the front of the appliance, or may be mounted or anchored at different locations, and may include more complex articulations. Therefore, the invention is not limited to the specific locations of a movable platform disclosed herein.

Next turning to FIG. 8-10, it may be desirable in some embodiments to provide cooling for a wireless power system integrated into a countertop appliance, and in some instances, the cooling may be provided by a cooling system (e.g., a cooling fan) that is also used to provide cooling for other electrical loads in the countertop appliance. It will be appreciated that a wireless power transmitter may generate substantial heat during operation, so cooling may be desirable to prevent overheating.

As illustrated in FIG. 8, for example, a countertop appliance 200, which is similar in many respect to countertop appliances 12 and 120 discussed above, may be implemented as a countertop microwave cooking appliance, and may include a housing 202 and a movable platform 204 supporting a wireless power transmitter 206 and linearly movable between storage and use positions by sliding along rails or sliders 208, 210. Movable platform 204 may also include a portion of a ducting arrangement 212 that includes an inlet port 214 that receives cooling air, routes it past wireless power transmitter 206, and exhausts the air through one or more outlets 216. Within housing 202, a duct 220 forming another portion of ducting arrangement 212 leads from a cooling fan 222 to an outlet port 224 that routes air from cooling fan 222 to inlet port 214. Cooling fan 222 is also positioned to cool one or more electrical loads in housing 202, e.g., a microwave power generator 226, such that the wireless power transmitter is cooled by the cooling fan that is utilized to cool at least a subset of the electrical loads in the countertop appliance.

Moreover, while in some embodiments a ducting arrangement may always route at least a portion of the air drawn into the housing by cooling fan 222, in the illustrated embodiment, ducting arrangement 212 is configured to only route air to inlet port 214 when movable platform 204 is in the use position. Specifically, with additional reference to FIGS. 9 and 10, when movable platform 204 is in the use position (FIG. 9), inlet port 214 is aligned with outlet port 224, thereby enabling air output by outlet port 224 to flow into inlet port 214. When movable platform 204 moves away from the use position (FIG. 10), inlet port 214 is separated from outlet port 224 (as illustrated at 214′), and moreover, a side surface 228 of movable platform 208 opposes and effectively blocks outlet port 224 such that air no longer flows through duct 220 and the cooling supplied by cooling fan 222 may be fully utilized to cool the electrical loads in housing 202. Side surface 228 may also, in some embodiments, be arranged to block outlet port 224 in the storage position and in the positions intermediate the use and storage positions, although in some embodiments, outlet port 224 may be blocked only in the storage position, or at least over only a portion of the intermediate positions.

It will also be appreciated that a countertop appliance may be integrated with a wirelessly powered appliance in a number of different manners. For example, power sharing may be utilized in countertop appliance to balance the power consumption of electric loads in the countertop appliance with the wireless power transmitter. Power may be temporarily discontinued to one or more electrical loads and/or to a wireless power transmitter, or requested operations may be denied in some embodiments when current power draw by the countertop appliance reaches a predetermined threshold, e.g., relative to a rated power capacity of the countertop appliance. Such power management may be handled by the controller of a countertop appliance in some embodiments, and power sensing hardware may be incorporated into a countertop appliance in some embodiments to monitor the current power draw of the countertop appliance.

In addition, in some embodiments, the user interface of a countertop appliance may be configured to additionally provide status information and/or control a wirelessly powered appliance being powered by the countertop appliance. A controller of a countertop appliance, for example, may be able to communicate with a wirelessly powered appliance, and via such communications, communicate commands to operate the wirelessly powered appliance and/or receive status information back from the wirelessly powered appliance. Such a controller may also receive identifying data from the wirelessly powered appliance when the wirelessly powered appliance is being powered by the wireless power transmitter and configure the user interface to operate the wirelessly powered appliance using the identifying data.

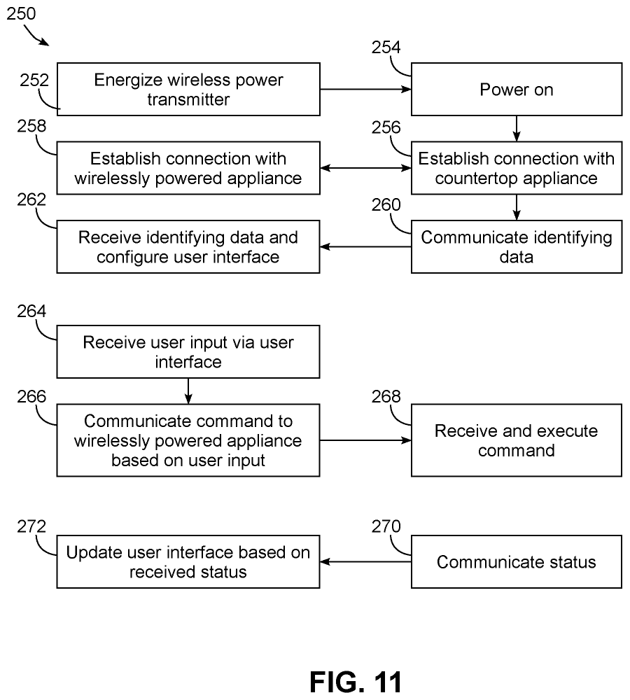

FIG. 11, for example, illustrates an example operational sequence 250 capable of being executed by a controller of a countertop appliance (right side of FIG. 11) and a controller of a wirelessly powered appliance being powered by the countertop appliance (left side of FIG. 11). In block 252, the countertop appliance may energize the wireless power transmitter (e.g., in response to user input to a user interface of the countertop appliance to turn on the wireless power transmitter, or in response to a movable platform being moved to a use position), and in block 254, the wirelessly powered appliance may turn on once the wireless power signal is detected. Then, in blocks 256 and 258 the countertop appliance and the wirelessly powered appliance may establish a connection with one another (e.g., using a Ki-compatible connection or other suitable connection), and in block 260, the wirelessly powered appliance may communicate identifying data to the countertop appliance, which in block 262 configures its user interface for controlling the wirelessly powered appliance.

The identifying data, for example, may identify various capabilities of the wirelessly powered appliance, which may include, for example, suggested user interface controls to be displayed on the user interface on the countertop appliance. Alternatively, identifying data may simply identify the type, model, etc. of the wirelessly powered appliance, with stored information in the countertop appliance and/or information separately downloaded by the countertop appliance used to determine a suitable configuration of the user interface of the countertop appliance for use in controlling the wirelessly powered appliance. As one example, the identifying data for a wirelessly powered pressure cooker (which may be received directly from the pressure cooker or may be determined from an identifier communicated by the pressure cooker) may include controls such as on/off, start, pause, temperature, pressure, mode, etc. controls, and may include display elements such as current temperature or setpoint temperature, remaining time, current status, or any other controls or display elements commonly found on pressure cookers.

Thus, as illustrated by blocks 264-268, any user input received through the user interface on the countertop appliance (block 264) may result in the generation of an appropriate command by the countertop appliance and communication of the command to the wirelessly powered appliance (block 266). Once received by the wirelessly powered appliance, the command may then be executed in block 268. Thus, for example, if a user selects a “start” button on the user interface of the countertop appliance, blocks 264-268 may cause the wirelessly powered pressure cooker to start a cooking cycle.

In addition, as illustrated by blocks 270-272, status data may be generated by the wirelessly powered appliance and communicated to the countertop appliance (block 270) and the user interface of the countertop appliance may be updated accordingly (block 272). Thus, for example, during a cooking cycle, a wirelessly powered pressure cooker may communicate current temperature, remaining time, etc. to the countertop appliance for display on the user interface thereof. Thus, the sequences of blocks 264-268 and blocks 270-272 may be repeated numerous times during operation of a wirelessly powered appliance during use thereof.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. A countertop appliance, comprising:
a housing configured to support the countertop appliance on a countertop;
one or more electrical loads coupled to the housing and configured to perform one or more primary appliance functions for the countertop appliance;
a movable platform; and
a wireless power transmitter supported by the movable platform and configured to generate a wireless power signal;
wherein the movable platform is movable between a use position and a storage position, wherein when in the use position, the movable platform positions the wireless power transmitter proximate to the countertop to power a wirelessly powered appliance positioned proximate thereto with the wireless power signal, and when in the storage position, the movable platform repositions the wireless power transmitter to reduce an overall countertop footprint of the countertop appliance.

2. The countertop appliance of claim 1, wherein the countertop appliance is a countertop microwave cooking appliance and the one or more electrical loads includes a microwave power generator.

3. The countertop appliance of claim 1, wherein the movable platform is configured to position the wireless power transmitter under the housing when in the storage position.

4. The countertop appliance of claim 3, wherein the movable platform is movable linearly between the use and storage positions.

5. The countertop appliance of claim 4, wherein the movable platform is supported under the housing by a pair of opposing slides.

6. The countertop appliance of claim 4, wherein the movable platform is movable in a direction between a front and a back of the housing, wherein when in the use position the wireless power transmitter is positioned in front of the housing on the countertop.

7. The countertop appliance of claim 4, wherein the movable platform is movable in a direction between left and right sides of the housing, wherein when in the use position the wireless power transmitter is positioned to a left or right of the housing on the countertop.

8. The countertop appliance of claim 3, wherein the movable platform is rotatable between the use and storage positions.

9. The countertop appliance of claim 1, wherein the movable platform is configured to position the wireless power transmitter against a side of the housing when in the storage position, and wherein the movable platform is rotatably coupled to the housing to flip down into the use position.

10. The countertop appliance of claim 1, further comprising an automated retraction/extension mechanism coupling the movable platform to the housing and configured to move the movable platform between the storage and use positions.

11. The countertop appliance of claim 1, wherein when in the use position, the movable platform is supported by the countertop.

12. The countertop appliance of claim 1, further comprising:
a cooling fan positioned to cool at least one of the one or more electrical loads coupled to the housing; and
a ducting arrangement configured to receive airflow generated by the cooling fan and route the airflow to the movable platform when in the use position to cool the wireless power transmitter during use.

13. The countertop appliance of claim 12, wherein the ducting arrangement includes an outlet port coupled to the housing and an inlet port coupled to the movable platform, wherein the outlet port is aligned with the inlet port when the movable platform is in the use position.

14. The countertop appliance of claim 13, wherein movement of the movable platform away from the use position separates the inlet port from the outlet port.

15. The countertop appliance of claim 13, wherein the movable platform blocks the outlet port when in the storage position.

16. The countertop appliance of claim 15, wherein the movable platform is movable linearly between the use and storage positions and includes a side surface, wherein the inlet port is disposed on the side surface, and wherein the side surface opposes the outlet port when the movable platform is in the storage position.

17. The countertop appliance of claim 1, wherein the wirelessly powered appliance is a first wirelessly powered appliance, and wherein the wireless power transmitter is configured to supply power to a second wirelessly powered appliance including one or more electric loads and lacking a power storage element sufficient to otherwise power the second wirelessly powered appliance.

18. The countertop appliance of claim 1, wherein the wireless power transmitter is further configured to inductively heat a utensil placed in proximity to the wireless power transmitter.

19. The countertop appliance of claim 1, further comprising:
a user interface; and
a controller coupled to the user interface and the one or more electrical loads to operate the one or more electrical loads in response to user input directed to the user interface;
wherein the controller is further configured to communicate with the wirelessly powered appliance when the wirelessly powered appliance is being powered by the wireless power transmitter and to communicate a command to operate the wirelessly powered appliance in response to user input directed to the user interface.

20. The countertop appliance of claim 19, wherein the controller is further configured to receive identifying data from the wirelessly powered appliance when the wirelessly powered appliance is being powered by the wireless power transmitter and to configure the user interface to operate the wirelessly powered appliance using the identifying data.
